(19) United States
(12) Patent Application Publication
(10) Pub. No.: US 2025/0336986 A1
(43) Pub. Date: Oct. 30, 2025

(54) METHOD OF MANUFACTURING CATALYST USING SUPERCRITICAL FLUID AND CATALYST PREPARED THEREBY

(71) Applicant: KOREA INSTITUTE OF SCIENCE AND TECHNOLOGY, Seoul (KR)

(72) Inventors: Sung Jong YOO, Seoul (KR); Jung Woo SHIM, Seoul (KR); Myeong-Geun KIM, Seoul (KR); Bora SEO, Seoul (KR); Hee-Young PARK, Seoul (KR); Katie Heeyum LIM, Seoul (KR); So Young LEE, Seoul (KR); Sung Ki CHO, Seoul (KR); Hyun Seo PARK, Seoul (KR); Jin Young KIM, Seoul (KR); Jong Hyun JANG, Seoul (KR)

(73) Assignee: KOREA INSTITUTE OF SCIENCE AND TECHNOLOGY, Seoul (KR)

(21) Appl. No.: 19/187,158

(22) Filed: Apr. 23, 2025

(30) Foreign Application Priority Data
Apr. 24, 2024 (KR) 10-2024-0054491

(51) Int. Cl. H01M 4/88; H01M 4/04; H01M 4/90; H01M 4/92; H01M 8/1018; H01M 8/1246

(52) U.S. Cl. CPC H01M 4/8817; H01M 4/0471; H01M 4/9083; H01M 4/92; H01M 8/1018; H01M 8/1246

(57) ABSTRACT

The present disclosure relates to a method for preparing a catalyst using a supercritical fluid and a catalyst produced thereby. According to the present disclosure, a catalyst wherein a catalytic metal is uniformly dispersed on a carbon support with high crystallinity and complex structure can be prepared using carbon dioxide in a supercritical state having the characteristics of a gas, such as high diffusion rate, low viscosity and surface tension, and the characteristics of a liquid, such as high density and solubility.

### CROSS-REFERENCE TO RELATED APPLICATION

This application claims priority to Korean Patent Application No. 10-2024-0054491 filed on Apr. 24, 2024, and all the benefits accruing therefrom under 35 U.S.C. § 119, the contents of which in its entirety are herein incorporated by reference.

### BACKGROUND

### 1. Field

The present disclosure relates to a method for preparing a catalyst using a supercritical fluid and a catalyst prepared thereby.

### 2. Description of the Related Art

Recently, as interest in renewable energy has increased, researches on fuel cells, secondary batteries, solar cells, etc. are being conducted actively. As the need for hydrogen energy is emphasized, technologies related to fuel cells and water electrolysis are emerging among these, and researches related to these technologies are being conducted actively. In fuel cells and water electrolysis devices, noble metal catalysts supported on carbon, which acts as a support, are used. However, carbon corrosion, which is a phenomenon in which carbon is oxidized electrochemically under operating conditions, has a negative impact on the durability of fuel cells and water electrolysis devices. To solve this problem, various supports are being studied, and among them, carbon with high crystallinity can suppress the carbon corrosion phenomenon. However, when carbon with high crystallinity is used, synthesis is difficult because the defects for catalyst supporting are not enough.

### REFERENCES OF RELATED ART

### Patent Documents

Patent document 1. Korean Patent Publication No. 10-2021-0064638.

### SUMMARY

The present disclosure is directed to providing a method for preparing a catalyst using a supercritical fluid, which includes: (A) a step of preparing a mixed solution in which a surface stabilizer, an additive, a carbon support, and a catalytic metal precursor are added to a first solvent; (B) a step of supplying carbon dioxide to a chamber containing the mixed solution and increasing the pressure and temperature of the chamber to create a supercritical state; and (C) a step of maintaining the supercritical state.

In addition, the present disclosure is directed to providing a catalyst prepared by the method for preparing a catalyst using a supercritical fluid.

In addition, the present disclosure is directed to providing a device including the catalyst, wherein the device is one or more device selected from a group consisting of a polymer electrolyte fuel cell (PEMFC), a solid oxide fuel cell (SOFC), and a secondary battery.

An aspect of the present disclosure provides a method for preparing a catalyst using a supercritical fluid, which includes: (A) a step of preparing a mixed solution in which a surface stabilizer, an additive, a carbon support, and a catalytic metal precursor are added to a first solvent; (B) a step of supplying carbon dioxide to a chamber containing the mixed solution and increasing the pressure and temperature of the chamber to create a supercritical state; and (C) a step of maintaining the supercritical state.

Another aspect of the present disclosure provides a catalyst prepared by the method for preparing a catalyst using a supercritical fluid.

Another aspect of the present disclosure provides a device including the catalyst, wherein the device is one or more selected from a group consisting of a polymer electrolyte fuel cell (PEMFC), a solid oxide fuel cell (SOFC), and a secondary battery.

The method for preparing a catalyst using a supercritical fluid of the present disclosure, which uses carbon dioxide in a supercritical state having the characteristics of a gas, such as high diffusion rate, low viscosity and surface tension, and the characteristics of a liquid, such as high density and solubility, allows the preparation of a catalyst wherein a catalytic metal is uniformly dispersed on a carbon support with high crystallinity and complex structure.

The effect of the present disclosure is not limited to that mentioned above. It should be understood that the effects of the present disclosure include all the effects that can be inferred from the following description.

### BRIEF DESCRIPTION OF THE DRAWINGS

FIG. 1 shows the pressure-temperature phase diagram of carbon dioxide.

FIG. 2 describes a method for preparing a catalyst using a supercritical fluid according to an exemplary embodiment of the present disclosure.

FIG. 3 shows transmission electron microscopy (TEM) images of catalysts prepared in Example 1 and Comparative Example of the present disclosure.

FIG. 4 shows a result of X-ray diffraction (XRD) analysis of catalysts prepared in Example 1 and Comparative Example 1 of the present disclosure.

FIG. 5 shows transmission electron microscopy (TEM) images of catalysts prepared in Example 1 (synthesized under stirring condition) and Example 2 (synthesized under non-stirring condition) of the present disclosure.

FIG. 6 shows transmission electron microscopy (TEM) images of catalysts prepared by varying the supercritical treatment pressure condition to 180, 230, 400, and 650 bar by controlling the amount of carbon dioxide in Example 1 of the present disclosure.

FIG. 7 shows a transmission electron microscopy (TEM) image of a catalyst prepared in Example 3 of the present disclosure.

### DETAILED DESCRIPTION

The advantages and features of the present disclosure and the methods for achieving them will become apparent with reference to the exemplary embodiments described in detail below together with the accompanying drawings. However, the present disclosure is not limited to the embodiments disclosed below, but may be implemented in various different forms, and these embodiments are provided only to make the disclosure of the present disclosure complete and to fully inform a person having ordinary skill in the art to which the present disclosure pertains of the scope of the invention, and the present disclosure is defined only by the scope of the claims.

In describing the present disclosure, if it is determined that a detailed description of a related known technology may unnecessarily obscure the gist of the present disclosure, the detailed description will be omitted. When the words “include”, “have”, and “consist of”, etc. are used in this specification, other components may also be added, unless “only” is used. Furthermore, terms such as “include”, “have”, etc. should not be construed as excluding the presence or addition of one or more other features, numbers, steps, components, or combinations thereof, but rather as specifying the presence of the features, numbers, steps, components, or combinations thereof described in the specification. Additionally, when a component is expressed in singular form, it includes the presence of plural components unless there is a special explicit description.

An aspect of the present disclosure relates to a method for preparing a catalyst using a supercritical fluid, which includes: (A) a step of preparing a mixed solution in which a surface stabilizer, an additive, a carbon support, and a catalytic metal precursor are added to a first solvent; (B) a step of supplying carbon dioxide to a chamber containing the mixed solution and increasing the pressure and temperature of the chamber to create a supercritical state; and (C) a step of maintaining the supercritical state.

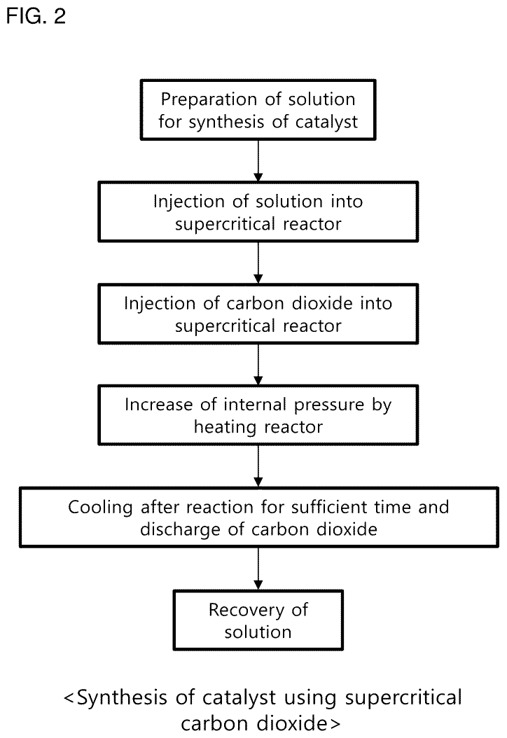

FIG. 2 describes a method for preparing a catalyst using a supercritical fluid according to an exemplary embodiment of the present disclosure.

As shown in FIG. 2, according to the present disclosure, a catalyst wherein a catalytic metal is uniformly dispersed on a carbon support with high crystallinity and complex structure can be prepared using carbon dioxide in a supercritical state having the characteristics of a gas, such as high diffusion rate, low viscosity and surface tension, and the characteristics of a liquid, such as high density and solubility.

Hereinafter, each step of the method for preparing a catalyst using a supercritical fluid of the present disclosure will be described in more detail.

(A) A Step of Preparing a Mixed Solution in which a Surface Stabilizer, an Additive, a Carbon Support, and a Catalytic Metal Precursor are Added to a First Solvent

The step (A) is a step of preparing a mixed solution in which a surface stabilizer, an additive, a carbon support, and a catalytic metal precursor are added to a first solvent.

In particular, the present disclosure is advantageous in that catalyst particles are formed uniformly on the carbon support since the mixed solution is prepared using a surface stabilizer and an additive in the step (A) as compared to a case where neither of them is used.

The first solvent may be one or more selected from a group consisting of water, dimethylformamide (DMF), methanol (MeOH), ethanol, propanol, isopropanol, t-butanol, n-butane, methoxyethanol, ethoxyethanol, dimethylacetamide, dimethylformamide, and N-methyl-2-pyrrolidone (NMP). More specifically, it may be dimethylformamide (DMF).

The surface stabilizer may be one or more selected from a group consisting of benzoic acid, oleylamine, and oleic acid. Specifically, it may be benzoic acid.

The amount of the surface stabilizer may be 50 to 150 mg, specifically 70 to 130 mg, more specifically 80 to 120 mg, and most specifically 90 to 110 mg, per 10 mL of the first solvent.

If the amount of the surface stabilizer is below the lower limit, it may be difficult to form catalytic metal particles. And conversely, if it exceeds the upper limit, impurities may increase rapidly.

The additive may be ethylene glycol.

The amount of the additive may be 0.1 to 10 parts by volume, specifically 0.5 to 7 parts by volume, more specifically 0.7 to 5 parts by volume, and most specifically 1 to 3 parts by volume, per 10 parts by volume of the first solvent.

If the amount of the additive is below the lower limit, formation of catalytic metal particles may be difficult. And conversely, if it exceeds the upper limit, impurities may increase rapidly.

The carbon support may include one or more selected from a group consisting of carbon nanopowder, carbon black, carbon nanotube (CNT), carbon nanofiber (CNF), graphene nanosheet (GNS), Ketjen black, graphene, graphene oxide, and carbon nanosphere. More specifically, it may be Ketjen black. Additionally, the carbon support may be heat-treated to further improve its crystallinity.

The amount of the carbon support may be 10 to 70 mg, specifically 15 to 50 mg, more specifically 20 to 40 mg, and most specifically 25 to 32 mg, per 10 mL of the first solvent.

If the carbon support is below the lower limit, the catalyst may grow excessively. And conversely, if it exceeds the upper limit, the amount of catalyst growing on the carbon may be small, resulting in reduced activity.

The catalytic metal precursor may include a catalytic metal.

The catalytic metal may be one or more selected from a group consisting of platinum (Pt), palladium (Pd), rhodium (Rh), ruthenium (Ru), nickel (Ni), cobalt (Co), iron (Fe), silver (Ag), gold (Au), copper (Cu), and tungsten (W). Most specifically, it may be platinum (Pt).

The amount of the catalytic metal precursor may be 15 to 45 mg, specifically 18 to 42 mg, more specifically 22 to 37 mg, and most specifically 25 to 33 mg, per 10 mL of the first solvent.

If the amount of the catalytic metal precursor is below the lower limit, the catalytic activity may be reduced. And conversely, if it exceeds the upper limit, the catalytic metal may aggregate.

### (B) A Step of Supplying Carbon Dioxide to a Chamber Containing the Mixed Solution and Increasing the Pressure and Temperature of the Chamber to Create a Supercritical State

The step (B) is a step of supplying carbon dioxide to a chamber containing the mixed solution and increasing the pressure and temperature of the chamber to create a supercritical state.

In the step (B), the temperature may be increased at a rate of 10 to 30° C./min, specifically 12 to 27° C./min, more specifically 13 to 25° C./min, and most specifically 15 to 23° C./min.

If the rate of temperature increase in the step (B) is outside the above range, the solvent may evaporate or the precursor may be decomposed thermally.

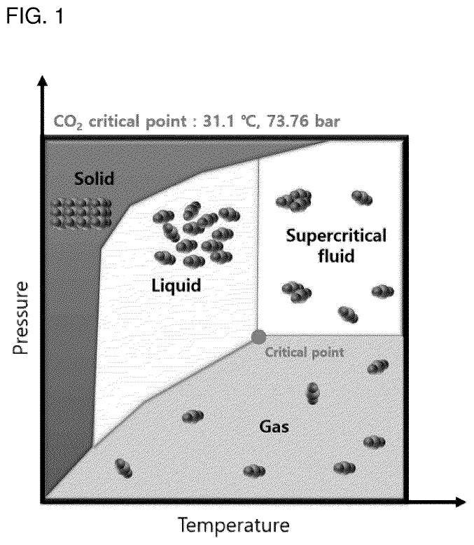

FIG. 1 shows the pressure-temperature phase diagram of carbon dioxide.

As shown in FIG. 1, carbon dioxide becomes a supercritical fluid at a temperature of 31.1° C. or higher and a pressure of 73.76 bar or higher. Therefore, the step (B) must be performed at 31.1° C. or higher and a pressure of 73.76 bar or higher.

In the step (B), the pressure may be increased to 150 to 1000 bar, specifically 220 to 900 bar, more specifically 400 to 800 bar, and most specifically 600 to 700 bar.

If the pressure is not increased to the lower limit in the step (B), a supercritical state may not be created or the metal particles in the catalyst being prepared may form excessively large particles, which may reduce catalytic activity. Conversely, if the pressure is increased above the upper limit, process stability and the structural stability of the catalyst being prepared may deteriorate rapidly.

In the step (B), the temperature may be increased to 100 to 250° C., specifically 110 to 230° C., more specifically 120 to 200° C., and most specifically 140 to 180° C.

If the temperature is not increased to the lower limit in the step (B), a supercritical state may not be created. And conversely, if the temperature is increased above the upper limit, the mechanical properties and structural stability of the catalyst being prepared may deteriorate.

### (C) A Step of Maintaining the Supercritical State

The step (C) is a step of supercritically treating the mixed solution by maintaining the created supercritical state.

The step (C) may be performed while stirring the mixed solution within the chamber. More specifically, it may be performed while stirring the mixed solution at a speed of 300 to 470 rpm, specifically 320 to 450 rpm, more specifically 330 to 430 rpm, and most specifically 350 to 400 rpm.

If the stirring speed in the step (C) is lower than the lower limit, the catalytic metal particles may not be supported sufficiently within the carbon support. And conversely, if it exceeds the upper limit, the catalytic metal supported on the carbon support may be lost.

The step (C) may be performed while maintaining the supercritical state for 0.5 to 5 hours, specifically 0.6 to 3 hours, more specifically 0.7 to 2 hours, and most specifically 0.8 to 1.2 hours.

If the supercritical state maintenance time in the step (C) is shorter than the lower limit, the loading rate of the catalytic metal may decrease rapidly. And conversely, if it exceeds the upper limit, the size of the catalytic metal may become nonuniform.

(D) a Step of Recovering a Catalyst from the Supercritically Treated Mixed Solution

After the step (C) above, a step (D) of recovering the catalyst from the supercritically treated mixed solution may be further included.

In the step (D), the catalyst may be recovered from the supercritically treated mixed solution by lowering the temperature and pressure of the chamber.

In the step (D), the temperature may be lowered to 32° C. or lower.

If the temperature is not lowered to 32° C. or lower, the contents may be discharged together undesirably since the mixed solution remains in a supercritical state.

In addition, the pressure must be lowered to 50 to 60 bar over a period of 30 minutes in the step (D) so that the catalyst can be recovered in high purity without discharge of the contents.

Although not explicitly described in the examples and comparative examples below, catalysts were prepared by the method for preparing a catalyst of the present disclosure under different conditions. Then, the long-term performance of a fuel cell was evaluated using the catalysts.

As a result, it was confirmed that the catalyst prepared by a method satisfying all of the conditions (1) to (10) below showed almost no decrease in performance over 800 cycles, and the particle size of the catalytic metal in the catalyst was maintained at a level equivalent to the initial size even after 800 cycles, indicating particularly excellent stability. However, when any of the following conditions was not satisfied, the prepared catalyst showed a decrease in performance after 600 cycles, the catalytic metal in the catalyst was lost around 800 cycles, or the particle size of the catalytic metal changed by more than 20% compared to the initial value, resulting in somewhat reduced stability.
(1) The first solvent is dimethylformamide (DMF).
(2) The surface stabilizer is benzoic acid, and is used in an amount of 90 to 110 mg per 10 mL of the first solvent.
(3) The additive is ethylene glycol, and is used in an amount of 1 to 3 parts by volume per 10 parts by volume of the first solvent.
(4) The carbon support is Ketjen black, and is used in an amount of 25 to 32 mg per 10 mL of the first solvent.
(5) The catalytic metal is platinum (Pt).
(6) The amount of the catalytic metal precursor is 25 to 33 mg per 10 ml of the first solvent.
(7) In the step (B), the temperature is increased to 140 to 180° C. at a rate of 15 to 23° C./min.
(8) The step (C) is performed while stirring the mixed solution in the chamber at a speed of 350 to 400 rpm.
(9) The step (C) is performed while maintaining the supercritical state for 0.8 to 1.2 hours.
(10) After the step (C), a step (D) of recovering a catalyst from the supercritically treated mixed solution by lowering the temperature of the chamber to 32° C. or lower is further included.

Another aspect of the present disclosure provides a catalyst prepared according to the method for preparing a catalyst.

The catalyst includes a carbon support; and a catalytic metal supported on the carbon support.

The catalytic metal supported on the carbon support may have a size of 1 to 20 nm, specifically 1 to 15 nm, more specifically 1 to 13 nm, and most specifically 2 to 7 nm.

Although the size of the catalytic metal supported on the carbon support may be controlled depending on the purpose of the catalyst, when used in a fuel cell, a size of 2 to 7 nm is the most preferable in that the fuel cell performance is maximized.

Another aspect of the present disclosure provides a device including the catalyst, wherein the device is one or more selected from a group consisting of a polymer electrolyte fuel cell (PEMFC), a solid oxide fuel cell (SOFC), and a secondary battery.

Hereinafter, the present disclosure will be described in more detail through examples, etc. However, the scope and content of the present disclosure cannot be interpreted as being reduced or limited by the examples, etc.

### Example 1

A mixed solution was prepared by mixing 30 mg of highly crystalline carbon (RTX), which was prepared by heat-treating Ketjen black (EC-600J D) as a carbon support at 2200° C. for 2 hours under an Ar atmosphere, 30 mg of Pt(acac)₂, 96 mg of benzoic acid, 2 mL of ethylene glycol, and 10 mL of DMF (dimethylformamide).

After the mixed solution was injected into a supercritical reactor, carbon dioxide was slowly injected into the chamber, so that the pressure was increased at a rate of 50 bar/min. Then, the temperature of the chamber was increased to 160° C. at a rate of 20° C./min using a heater to make the carbon dioxide into a supercritical state. Next, the supercritical state was maintained for 1 hour while stirring the mixed solution at 370 rpm using a magnetic stirrer.

Next, after the supercritical treatment was completed, the temperature was lowered to 32° C. or lower, and the pressure was lowered to discharge the carbon dioxide. Then, a catalyst was recovered.

### Example 2

A catalyst was prepared in the same manner as in Example 1, except that the mixed solution was not stirred during the supercritical treatment step.

### Example 3

A catalyst was prepared in the same manner as in Example 1, except that highly crystalline carbon (TCS) prepared by heat-treating Ketjen black (EC-600J D) with higher crystallinity than RTX carbon carbon at 2700° C. for 2 hours under an Ar atmosphere was used as a carbon support.

### Comparative Example 1

A mixed solution was prepared by mixing 30 mg of highly crystalline carbon (RTX), which was prepared by heat-treating Ketjen black (EC-600J D) as a carbon support at 2200° C. for 2 hours under an Ar atmosphere, 30 mg of Pt(acac)₂, 96 mg of benzoic acid, 2 mL of ethylene glycol, and 10 mL of DMF (dimethylformamide). Next, the mixed solution was stirred at 370 rpm using a magnetic stirrer and reacted at 160° C. for 1 hour. After the synthesis was completed, the catalyst was recovered.

### Test Example 1. Transmission Electron Microscopy (TEM)

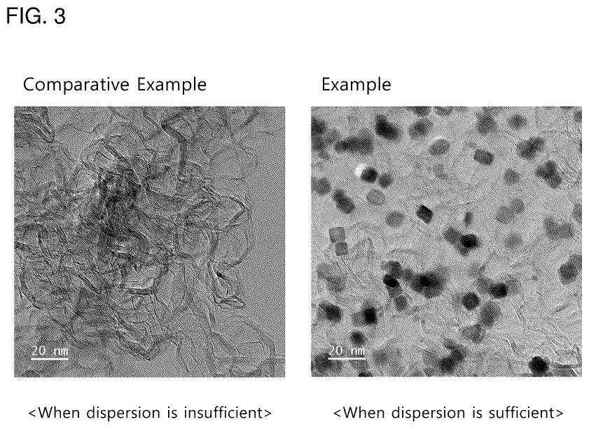

The size of platinum particles in the catalysts synthesized in Example 1 and Comparative Example 1 was analyzed using a transmission electron microscope (TEM). The result is shown in FIG. 3.

FIG. 3 shows the transmission electron microscopy (TEM) images of the catalysts prepared in Example 1 and Comparative Example of the present disclosure.

As shown in FIG. 3, the catalyst prepared in Comparative Example 1 does not show black particles, indicating that platinum particles were not formed on the highly crystalline RTX carbon, whereas platinum particles were formed with high crystallinity on the RTX carbon for the catalyst synthesized in Example 1 under the supercritical condition.

### Test Example 2. X-Ray Diffraction (XRD)

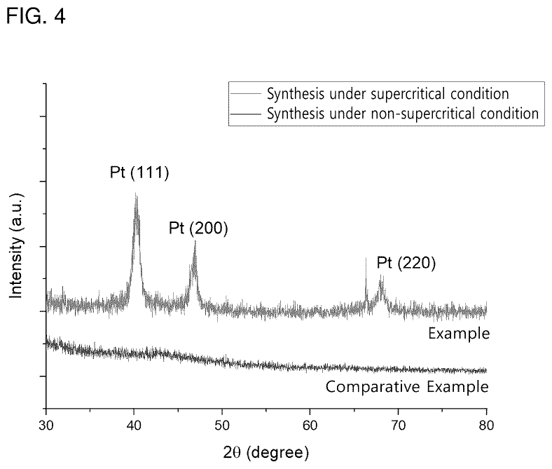

X-ray diffraction analysis was performed on the catalysts synthesized in Example 1 and Comparative Example 1. The result is shown in FIG. 4.

FIG. 4 shows a result of X-ray diffraction (XRD) analysis of catalysts prepared in Example 1 and Comparative Example 1 of the present disclosure.

As shown in FIG. 4, whereas peaks corresponding to Pt did not appear at all for Comparative Example 1 (black), the peaks corresponding to Pt, i.e., (111), (200) and (220), appeared clearly for Example 1 (red). Through this, it can be seen that although platinum particles are not formed on RTX carbon when the synthesis is performed under non-supercritical condition, the platinum particles are formed well when the synthesis is performed under supercritical condition, as shown in FIG. 3.

### Test Example 3-1. Transmission Electron Microscopy (TEM) of Catalysts Prepared Under Different Stirring Conditions

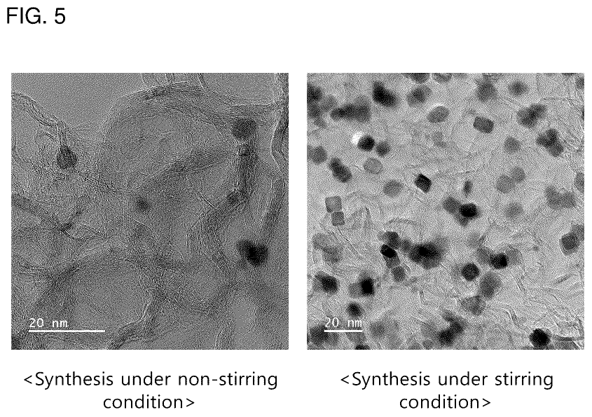

FIG. 5 shows the transmission electron microscopy (TEM) images of the catalysts prepared in Example 1 (synthesized under stirring condition) and Example 2 (synthesized under non-stirring condition) of the present disclosure.

As shown in FIG. 5, although a small number of particles were formed for Example 2, a large number of particles with superior crystallinity were formed for Example 1.

### Test Example 3-2. Transmission Electron Microscopy (TEM) of Catalysts Prepared Under Different Carbon Dioxide Pressures

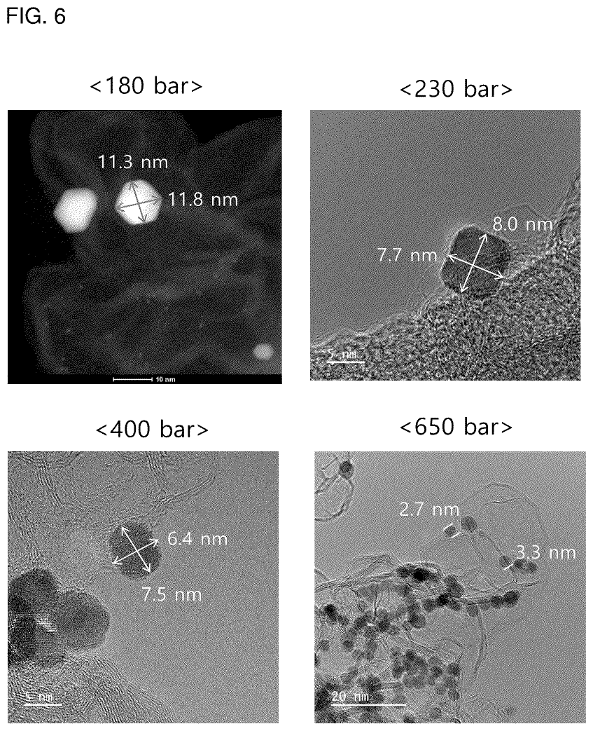

The transmission electron microscopy (TEM) images of the catalysts prepared by controlling the amount of carbon dioxide injected in Example 1 and increasing the temperature to 160° C. so that the final pressures are set to 180, 230, 400, and 650 bar are shown in FIG. 6.

FIG. 6 shows the transmission electron microscopy (TEM) images of the catalysts prepared by varying the supercritical treatment pressure condition to 180, 230, 400, and 650 bar by controlling the amount of carbon dioxide in Example 1 of the present disclosure.

As shown in FIG. 6, it was confirmed that platinum particles with an average size of 11.55 nm were formed when the pressure was 180 bar during the supercritical treatment. The average size was 7.85 nm at 230 bar, 6.95 nm at 400 bar, and 3 nm at 650 bar. Accordingly, it was confirmed that the size of the platinum particles decreased as the pressure was increased.

### Test Example 4. Transmission Electron Microscopy (TEM) of Catalysts Prepared Under Different Carbon Dioxide Pressures

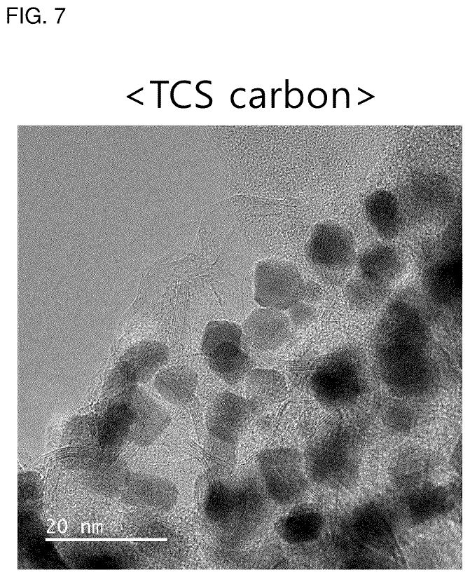

The transmission electron microscopy (TEM) image of the catalyst prepared in Example 3 is shown in FIG. 7.

FIG. 7 shows the transmission electron microscopy (TEM) image of the catalyst prepared in Example 3 of the present disclosure.

As shown in FIG. 7, it can be seen that platinum particles were formed well regardless of the type of carbon.

Although the exemplary embodiments of the present disclosure have been described above, those skilled in the art can add, change or delete elements without departing from the spirit of the present disclosure as set forth in the appended claims. The present disclosure may be modified and changed in various ways, which will also be included within the scope of the present disclosure.

What is claimed is:

1. A method for preparing a catalyst using a supercritical fluid, comprising:
(A) a step of preparing a mixed solution in which a surface stabilizer, an additive, a carbon support, and a catalytic metal precursor are added to a first solvent;
(B) a step of supplying carbon dioxide to a chamber comprising the mixed solution and increasing the pressure and temperature of the chamber to create a supercritical state; and
(C) a step of maintaining the supercritical state.

2. The method for preparing a catalyst using a supercritical fluid according to claim 1, wherein the first solvent is one or more selected from a group consisting of water, dimethylformamide (DMF), methanol (MeOH), ethanol, propanol, isopropanol, t-butanol, n-butane, methoxyethanol, ethoxyethanol, dimethylacetamide, dimethylformamide, and N-methyl-2-pyrrolidone (NMP).

3. The method for preparing a catalyst using a supercritical fluid according to claim 1, wherein the surface stabilizer is one or more selected from a group consisting of benzoic acid, oleylamine, and oleic acid.

4. The method for preparing a catalyst using a supercritical fluid according to claim 1, wherein the amount of the surface stabilizer is 50 to 150 mg per 10 ml of the first solvent.

5. The method for preparing a catalyst using a supercritical fluid according to claim 1, wherein the additive is ethylene glycol.

6. The method for preparing a catalyst using a supercritical fluid according to claim 1, wherein the amount of the additive is 0.1 to 10 parts by volume for 10 parts by volume of the first solvent.

7. The method for preparing a catalyst using a supercritical fluid according to claim 1, wherein the carbon support is one or more selected from a group consisting of carbon nanopowder, carbon black, carbon nanotube (CNT), carbon nanofiber (CNF), graphene nanosheet (GNS), Ketjen black, graphene, graphene oxide, and carbon nanosphere.

8. The method for preparing a catalyst using a supercritical fluid according to claim 1, wherein the amount of the carbon support is 10 to 70 mg per 10 ml of the first solvent.

9. The method for preparing a catalyst using a supercritical fluid according to claim 1, wherein the catalytic metal is selected from a group consisting of platinum (Pt), palladium (Pd), rhodium (Rh), ruthenium (Ru), nickel (Ni), cobalt (Co), iron (Fe), silver (Ag), gold (Au), copper (Cu), and tungsten (W).

10. The method for preparing a catalyst using a supercritical fluid according to claim 1, wherein the catalytic metal precursor is used in an amount of 15 to 45 mg per 10 mL of the first solvent.

11. The method for preparing a catalyst using a supercritical fluid according to claim 1, wherein, in the step (B), the pressure is increased to 150 to 1000 bar.

12. The method for preparing a catalyst using a supercritical fluid according to claim 1, wherein, in the step (B), the temperature is increased at a rate of 10 to 30° C./min.

13. The method for preparing a catalyst using a supercritical fluid according to claim 1, wherein, in the step (B), the temperature is increased to 100 to 250° C.

14. The method for preparing a catalyst using a supercritical fluid according to claim 1, wherein, the step (C) is performed while stirring the mixed solution in the chamber at 300 to 470 rpm.

15. The method for preparing a catalyst using a supercritical fluid according to claim 1, wherein the step (C) is performed while maintaining the supercritical state for 0.5 to 5 hours.

16. The method for preparing a catalyst using a supercritical fluid according to claim 1, which further comprises, after the step (C), (D) a step of lowering the temperature and pressure of the chamber to recover a catalyst from the supercritically treated mixed solution.

17. The method for preparing a catalyst using a supercritical fluid according to claim 1, wherein
the first solvent is dimethylformamide (DMF),
the surface stabilizer is benzoic acid, and is used in an amount of 90 to 110 mg per 10 mL of the first solvent,
the additive is ethylene glycol, and is used in an amount of 1 to 3 parts by volume for 10 parts by volume of the first solvent,
the carbon support is Ketjen black, and is used in an amount of 25 to 32 mg per 10 mL of the first solvent,
the catalytic metal is platinum (Pt),
the amount of the catalytic metal precursor is 25 to 33 mg per 10 ml of the first solvent,
in the step (B), the temperature is increased to 140 to 180° C. at a rate of 15 to 23° C./min,
the step (C) is performed while stirring the mixed solution in the chamber at a speed of 350 to 400 rpm,
the step (C) is performed while maintaining the supercritical state for 0.8 to 1.2 hours, and
after the step (C), a step (D) of lowering the temperature of the chamber to 32° C. or lower to recover a catalyst from the supercritically treated mixed solution is further comprised.

18. A catalyst prepared according to claim 1.

19. A device comprising the catalyst of claim 18, wherein the device is one or more device selected from a group consisting of a polymer electrolyte fuel cell (PEMFC), a solid oxide fuel cell (SOFC), and a secondary battery.
